(19) United States
(12) Patent Application Publication
(10) Pub. No.: US 2026/0142926 A1
(43) Pub. Date: May 21, 2026

(54) SUPPORTING LOW LATENCY LOW LOSS IN WIRELESS AND WIRELINE CONVERGENCE

(71) Applicant: Juniper Networks, Inc., Sunnyvale, CA (US)

(72) Inventor: Venkatesh PADEBETTU, Bangalore (IN)

(21) Appl. No.: 19/037,927

(22) Filed: Jan. 27, 2025

(30) Foreign Application Priority Data
Nov. 21, 2024 (IN) 202441090533

(51) Int. Cl. H04L 47/2441; H04L 45/00; H04L 47/11

(52) U.S. Cl. CPC H04L 47/2441; H04L 45/68; H04L 47/11

(57) ABSTRACT

A device may receive a configuration associated with one or more of prioritizing low latency low loss (L4S) packets, marking L4S packets, or reflecting L4S packets, may identify upstream and downstream L4S packets based on the configuration. The device may prioritize the upstream and downstream L4S packets based on the configuration.

### CROSS-REFERENCE TO RELATED APPLICATION

This application claims priority to Indian Provisional Application No. 202441090533 entitled “SUPPORTING LOW LATENCY LOW LOSS IN WIRELESS AND WIRELINE CONVERGENCE,” filed on Nov. 21, 2024. The entire content of which is expressly incorporated herein by reference.

### BACKGROUND

Low latency low loss (L4S) is an upcoming technology that provides a method to avoid congestion by using Internet protocol (IP) explicit congestion notification (ECN) bits to indicate congestion instead of marking.

### SUMMARY

Some implementations described herein relate to a method. The method may include receiving a configuration associated with one or more of prioritizing L4S packets, marking L4S packets, or reflecting L4S packets, and identifying upstream and downstream L4S packets based on the configuration. The method may include prioritizing the upstream and downstream L4S packets based on the configuration.

Some implementations described herein relate to a device. The device may include one or more memories and one or more processors. The one or more processors may be configured to receive a configuration associated with one or more of prioritizing L4S packets, marking L4S packets, or reflecting L4S packets, and identify upstream and downstream L4S packets based on the configuration. The one or more processors may be configured to prioritize the upstream and downstream L4S packets based on the configuration, and copy an IP type of service (TOS) ECN of an upstream L4S packet to a tunnel header or to an inner downstream L4S packet based on the configuration.

Some implementations described herein relate to a non-transitory computer-readable medium that stores a set of instructions. The set of instructions, when executed by one or more processors of a device, may cause the device to receive, via a command line interface associated with the device or from a residential gateway associated with the device, a configuration associated with one or more of prioritizing L4S packets, marking L4S packets, or reflecting L4S packets. The set of instructions, when executed by one or more processors of the device, may cause the device to identify upstream and downstream L4S packets based on the configuration, and prioritize the upstream and downstream L4S packets based on the configuration.

### BRIEF DESCRIPTION OF THE DRAWINGS

FIGS. 1A-1C are diagrams of an example associated with supporting L4S in wireless and wireline convergence.

FIG. 2 is a diagram of an example environment in which systems and/or methods described herein may be implemented.

FIGS. 3 and 4 are diagrams of example components of one or more devices of FIG. 2.

FIG. 5 is a flowchart of example processes for supporting L4S in wireless and wireline convergence.

### DETAILED DESCRIPTION

The following detailed description of example implementations refers to the accompanying drawings. The same reference numbers in different drawings may identify the same or similar elements.

An access gateway function (AGF) enables interworking of wireline-connected devices and a core network (e.g., a fifth generation (5G) core network). In adaptive mode, the AGF manages access connections between a fixed network (FN) residential gateway (RG) and the 5G core network by providing 5G signaling. The AGF may provide for IP connectivity, authentication, authorization and accounting (AAA) services, quality of service (QoS) to subscribers of the FN RG, and a connection between the 5G core network and the FN RG. The AGF offers ease of migration for a subscriber (e.g., with existing customer premises equipment (CPE), such as an FN RG) to the 5G core network, and supports existing FN RGs and existing hardware. The AGF optimizes data plane traffic with a user plane function (UPF), resulting in improved performance, and eases deployment by enabling a co-location of a broadband network gateway (BNG), the AGF, and the UPF on the same platform. However, the AGF is unable to prioritize traffic marked as L4S in the IP ECN and/or marked to indicate congestion in the IP ECN. Further, current prioritization and marking techniques are insufficient to obtain the benefit of L4S due to General Packet Radio Service (GPRS) Tunnelling Protocol-User Plane (GTP-U) tunnels from AGF to UPF.

Thus, current techniques for providing L4S consume computing resources (e.g., processing resources, memory resources, communication resources, and/or the like), networking resources, and/or other resources associated with failing to prioritize traffic marked as L4S or marked to indicate congestion, losing traffic due to failing to prioritize traffic marked as L4S or marked to indicate congestion, providing a poor user experience due to failing to prioritize traffic marked as L4S or marked to indicate congestion, and/or the like.

Some implementations described herein provide a device that supports L4S in wireless and wireline convergence. For example, the device may receive a configuration associated with one or more of prioritizing L4S packets, marking L4S packets, or reflecting L4S packets, and may identify upstream and downstream L4S packets based on the configuration. The device may prioritize the upstream and downstream L4S packets based on the configuration. Alternatively, or additionally, the device may receive an indication of downstream congestion, may mark downstream L4S packets based on the configuration and the indication of the downstream congestion, and may queue the downstream L4S packets based on the configuration and the indication of the downstream congestion. Alternatively, or additionally, the device may copy an IP type of service (TOS) ECN of an upstream L4S packet to a tunnel header or to an inner downstream L4S packet based on the configuration.

In this way, the device supports L4S in wireless and wireline convergence. For example, the device may receive a configuration that triggers the device to prioritize, mark and/or reflect L4S packets. The device may identify and prioritize upstream and downstream L4S packets based on the configuration. Based on the configuration, the device may mark and queue (e.g., in an L4S queue) downstream L4S packets if there is an overflow and instead of dropping the L4S packets. If an upstream packet is marked as L4S, the device may copy the IP TOS ECN to the GTP-U tunnel IP header based on the configuration. If a downstream packet is marked as L4S in the GTP-U tunnel IP header, the device may copy the IP TOS ECN to the inner packet before forwarding to the subscriber. Thus, the device (e.g., the UPF, the AGF, and/or the BNG) may conserve computing resources, networking resources, and/or other resources that would have otherwise been consumed by failing to prioritize traffic marked as L4S or marked to indicate congestion, losing traffic due to failing to prioritize traffic marked as L4S or marked to indicate congestion, providing a poor user experience due to failing to prioritize traffic marked as L4S or marked to indicate congestion, and/or the like.

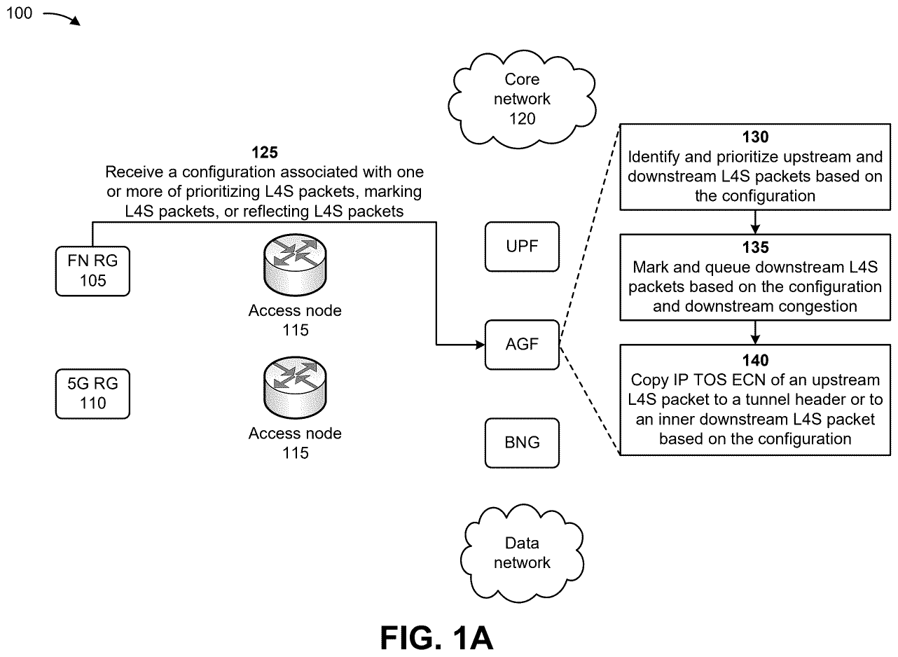

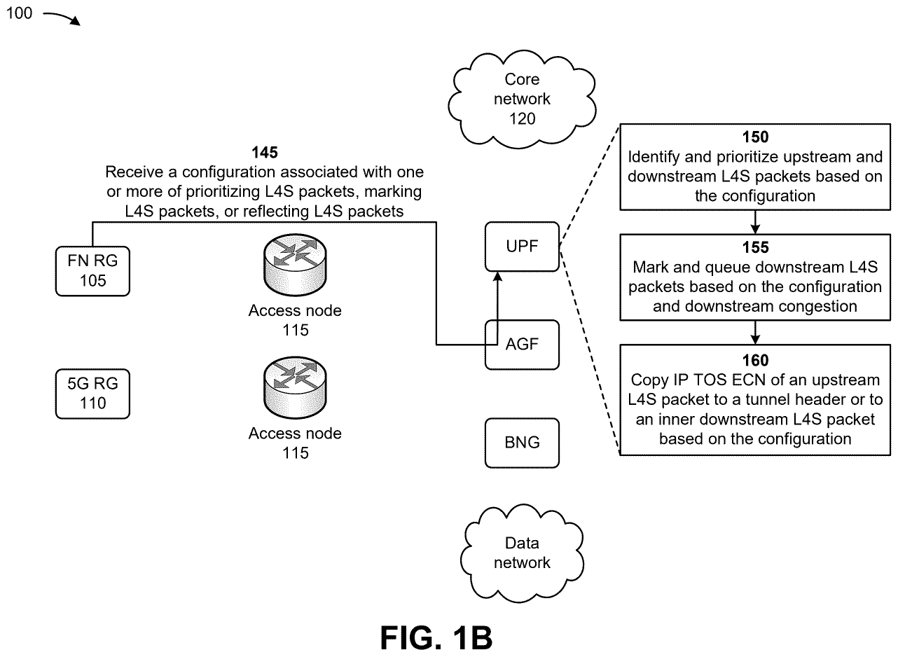

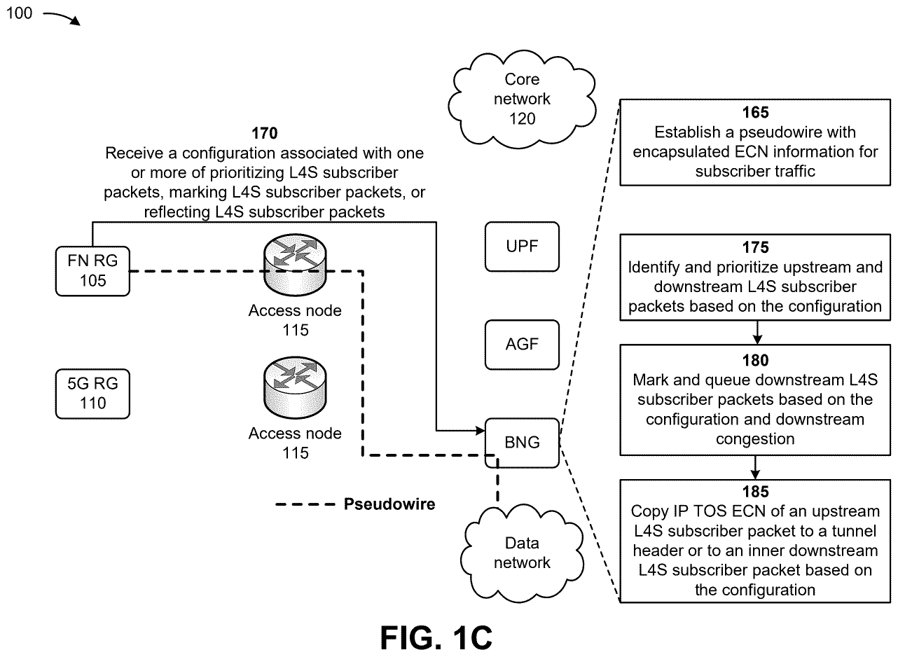

FIGS. 1A-1C are diagrams of an example 100 associated with supporting L4S in wireless and wireline convergence. As shown in FIGS. 1A-1C, the example 100 includes an FN RG 105, a 5G RG 110, access nodes 115, a core network 120, a data network, a UPF, an AGF, and a BNG. Further details of the FN RG 105, the 5G RG 110, the access nodes 115, the core network 120, the data network, the UPF, the AGF, and the BNG are provided elsewhere herein.

As further shown in FIG. 1A, and by reference number 125, the AGF may receive a configuration associated with one or more of prioritizing L4S packets, marking L4S packets, or reflecting L4S packets. For example, a user (e.g., a network engineer) may utilize a command line interface (CLI) of the AGF to provide the configuration to the AGF. Alternatively, the AGF may receive the configuration from the FN RG 105 or the 5G RG 110. In some implementations, the AGF may be capable of handling L4S packets and the configuration may include information that triggers prioritizing L4S packets, information that triggers marking L4S packets, and/or information that triggers reflecting L4S packets. The information that triggers prioritizing L4S packets may cause the AGF to prioritize upstream and downstream L4S packets associated with the AGF. The information that triggers marking L4S packets may cause the AGF to mark and queue downstream L4S packets associated with the AGF. The information that triggers reflecting L4S packets may cause the AGF to copy an IP TOS ECN of an upstream L4S packet (e.g., associated with the AGF) to a tunnel header or to an inner downstream L4S packet associated with the AGF.

In some implementations, the AGF may utilize the information that triggers prioritizing L4S packets for a first set of subscribers, may utilize the information that triggers marking L4S packets for a second set of subscribers that is different than the first set of subscribers, and may utilize the information that triggers reflecting L4S packets for a third set of subscribers that is different than the first set of subscribers and the second set of subscribers.

As further shown in FIG. 1A, and by reference number 130, the AGF may identify and prioritize upstream and downstream L4S packets based on the configuration. For example, if the configuration includes the information that triggers prioritizing L4S packets, the AGF may identify upstream and downstream L4S packets based on the IP TOS ECNs associated with upstream and downstream packets received by the AGF. The AGF may prioritize the upstream and downstream L4S packets based on the configuration and in multiple ways. In some implementations, the AGF may prioritize the upstream and downstream L4S packets by utilizing a first queue for L4S traffic and a second queue for non-L4S traffic. In such implementations, the AGF may enable prioritized dequeuing for the L4S traffic of the first queue over the non-L4S traffic of the second queue. Alternatively, or additionally, the AGF may prioritize the upstream and downstream L4S packets by queuing L4S traffic at a head of a queue instead of a tail of the queue. In such implementations, the AGF may queue non-L4S traffic at the tail of the queue. In this way, the AGF may dequeue the L4S traffic before the non-L4S traffic from the queue.

As further shown in FIG. 1A, and by reference number 135, the AGF may mark and queue downstream L4S packets based on the configuration and downstream congestion. For example, if the configuration includes the information that triggers marking L4S packets, the AGF may determine whether there is congestion associated with downstream traffic. For example, the AGF may determine that there is downstream congestion when there is an overflow in a queue associated with the downstream traffic. Instead of dropping L4S packets of the downstream traffic because of the overflow, the AGF may mark the L4S packets (e.g., utilizing IP TOS indicators) and may queue the L4S packets in an L4S queue. This may indicate to an application or a source of the L4S packets that there is congestion in the network and that data rates need to be adjusted.

As further shown in FIG. 1A, and by reference number 140, the AGF may copy an IP TOS ECN of an upstream L4S packet to a tunnel header or to an inner downstream L4S packet based on the configuration. For example, if the configuration includes the information that triggers reflecting L4S packets, the AGF may copy an IP TOS ECN of a packet, marked as L4S in the upstream direction, to a GTP-U tunnel IP header for a tunnel directed toward the UPF. In the downstream direction, if L4S is marked on the GTP-U tunnel IP header (e.g., for traffic received from the UPF), the AGF may copy the IP TOS ECN to the inner downstream L4S packet before forwarding the packet to a subscriber. Thus, the AGF may reflect the IP TOS ECN from an inner payload to an outer payload of an L4S packet at tunnel encapsulation or may reflect the IP TOS ECN from an outer payload to an inner payload of an L4S packet at tunnel decapsulation.

As shown in FIG. 1B, and by reference number 145, the UPF may receive a configuration associated with one or more of prioritizing L4S packets, marking L4S packets, or reflecting L4S packets. For example, a user (e.g., a network engineer) may utilize a CLI of the UPF to provide the configuration to the UPF. Alternatively, the UPF may receive the configuration from the FN RG 105 or the 5G RG 110, via the AGF. In some implementations, the UPF may be capable of handling L4S packets and the configuration may include information that triggers prioritizing L4S packets, information that triggers marking L4S packets, and/or information that triggers reflecting L4S packets. The information that triggers prioritizing L4S packets may cause the UPF to prioritize upstream and downstream L4S packets associated with the UPF. The information that triggers marking L4S packets may cause the UPF to mark and queue downstream L4S packets associated with the UPF. The information that triggers reflecting L4S packets may cause the UPF to copy an IP TOS ECN of an upstream L4S packet (e.g., associated with the UPF) to a tunnel header or to an inner downstream L4S packet associated with the UPF.

In some implementations, the UPF may utilize the information that triggers prioritizing L4S packets for a first set of subscribers, may utilize the information that triggers marking L4S packets for a second set of subscribers that is different than the first set of subscribers, and may utilize the information that triggers reflecting L4S packets for a third set of subscribers that is different than the first set of subscribers and the second set of subscribers.

As further shown in FIG. 1B, and by reference number 150, the UPF may identify and prioritize upstream and downstream L4S packets based on the configuration. For example, if the configuration includes the information that triggers prioritizing L4S packets, the UPF may identify upstream and downstream L4S packets based on the IP TOS ECNs associated with upstream and downstream packets received by the UPF. The UPF may prioritize the upstream and downstream L4S packets based on the configuration and in multiple ways. In some implementations, the UPF may prioritize the upstream and downstream L4S packets by utilizing a first queue for L4S traffic and a second queue for non-L4S traffic. In such implementations, the UPF may enable prioritized dequeuing for the L4S traffic of the first queue over the non-L4S traffic of the second queue. Alternatively, or additionally, the UPF may prioritize the upstream and downstream L4S packets by queuing L4S traffic at a head of a queue instead of a tail of the queue. In such implementations, the UPF may queue non-L4S traffic at the tail of the queue. In this way, the UPF may dequeue the L4S traffic before the non-L4S traffic from the queue.

As further shown in FIG. 1B, and by reference number 155, the UPF may mark and queue downstream L4S packets based on the configuration and downstream congestion. For example, if the configuration includes the information that triggers marking L4S packets, the UPF may determine whether there is congestion associated with downstream traffic. For example, the UPF may determine that there is downstream congestion when there is an overflow in a queue associated with the downstream traffic. Instead of dropping L4S packets of the downstream traffic because of the overflow, the UPF may mark the L4S packets (e.g., utilizing IP TOS indicators) and may queue the L4S packets in an L4S queue. This may indicate to an application or a source of the L4S packets that there is congestion in the network and that data rates need to be adjusted.

As further shown in FIG. 1B, and by reference number 160, the UPF may copy an IP TOS ECN of an upstream L4S packet to a tunnel header or to an inner downstream L4S packet based on the configuration. For example, if the configuration includes the information that triggers reflecting L4S packets, the UPF may copy an IP TOS ECN of a packet, marked as L4S in the upstream direction, to a GTP-U tunnel IP header for a tunnel directed toward the core network 120. In the downstream direction, if L4S is marked on the GTP-U tunnel IP header (e.g., for traffic received from the core network 120), the UPF may copy the IP TOS ECN to the inner downstream L4S packet before forwarding the packet to a subscriber, via the AGF. Thus, the UPF may reflect the IP TOS ECN from an inner payload to an outer payload of an L4S packet at tunnel encapsulation or may reflect the IP TOS ECN from an outer payload to an inner payload of an L4S packet at tunnel decapsulation.

As shown in FIG. 1C, and by reference number 165, the BNG may establish a pseudowire with encapsulated ECN information for subscriber traffic. For example, in BNG control and user plane separation (CUPS), the BNG may group subscribers into subscriber groups (SGRPs). A subscriber group may be active on a user plane of the BNG and may be in a standby state on another user plane of the BNG for redundancy cases. Each subscriber group may be associated with a pseudowire established by the BNG. In case of failure of the user plane, all of the subscriber groups active on the user plane will not be able to process traffic, and a detection mechanism may trigger standby subscriber groups on the other user plane to become active and process the traffic. The pseudowires associated with the subscriber groups may switch to a new user plane hosting the subscriber group in active state. In some implementations, the BNG may establish a pseudowire that encapsulates ECN information for all subscriber traffic.

As further shown in FIG. 1C, and by reference number 170, the BNG may receive a configuration associated with one or more of prioritizing L4S subscriber packets, marking L4S subscriber packets, or reflecting L4S subscriber packets. For example, a user (e.g., a network engineer) may utilize a CLI of the BNG to provide the configuration to the BNG. Alternatively, the BNG may receive the configuration from the FN RG 105 or the 5G RG 110. In some implementations, the configuration may include information that triggers prioritizing L4S packets, information that triggers marking L4S packets, and/or information that triggers reflecting L4S packets. The information that triggers prioritizing L4S packets may cause the BNG to prioritize upstream and downstream L4S packets associated with the BNG. The information that triggers marking L4S packets may cause the BNG to mark and queue downstream L4S packets associated with the BNG. The information that triggers reflecting L4S packets may cause the BNG to copy an IP TOS ECN of an upstream L4S packet (e.g., associated with the BNG) to a tunnel header or to an inner downstream L4S packet associated with the BNG.

In some implementations, the BNG may utilize the information that triggers prioritizing L4S packets for a first set of subscribers, may utilize the information that triggers marking L4S packets for a second set of subscribers that is different than the first set of subscribers, and may utilize the information that triggers reflecting L4S packets for a third set of subscribers that is different than the first set of subscribers and the second set of subscribers.

As further shown in FIG. 1C, and by reference number 175, the BNG may identify and prioritize upstream and downstream L4S subscriber packets based on the configuration. For example, if the configuration includes the information that triggers prioritizing L4S packets, the BNG may identify upstream and downstream L4S packets based on the IP TOS ECNs associated with upstream and downstream packets received by the BNG. The BNG may prioritize the upstream and downstream L4S packets based on the configuration and in multiple ways. In some implementations, the BNG may prioritize the upstream and downstream L4S packets by utilizing a first queue for L4S traffic and a second queue for non-L4S traffic. In such implementations, the BNG may enable prioritized dequeuing for the L4S traffic of the first queue over the non-L4S traffic of the second queue. Alternatively, or additionally, the BNG may prioritize the upstream and downstream L4S packets by queuing L4S traffic at a head of a queue instead of a tail of the queue. In such implementations, the BNG may queue non-L4S traffic at the tail of the queue. In this way, the BNG may dequeue the L4S traffic before the non-L4S traffic from the queue.

As further shown in FIG. 1C, and by reference number 180, the BNG may mark and queue downstream L4S subscriber packets based on the configuration and downstream congestion. For example, if the configuration includes the information that triggers marking L4S packets, the BNG may determine whether there is congestion associated with downstream traffic. For example, the BNG may determine that there is downstream congestion when there is an overflow in a queue associated with the downstream traffic. Instead of dropping L4S packets of the downstream traffic because of the overflow, the BNG may mark the L4S packets (e.g., utilizing IP TOS indicators) and may queue the L4S packets in an L4S queue. This may indicate to an application or a source of the L4S packets that there is congestion in the network and that data rates need to be adjusted.

As further shown in FIG. 1C, and by reference number 185, the BNG may copy an IP TOS ECN of an upstream L4S subscriber packet to a tunnel header or to an inner downstream L4S subscriber packet based on the configuration. For example, if the configuration includes the information that triggers reflecting L4S packets, the BNG may copy an IP TOS ECN of a packet, marked as L4S in the upstream direction, to a GTP-U tunnel IP header for a tunnel directed toward the data network. In the downstream direction, if L4S is marked on the GTP-U tunnel IP header (e.g., for traffic received from the data network), the BNG may copy the IP TOS ECN to the inner downstream L4S packet before forwarding the packet to a subscriber. Thus, the BNG may reflect the IP TOS ECN from an inner payload to an outer payload of an L4S packet at tunnel encapsulation or may reflect the IP TOS ECN from an outer payload to an inner payload of an L4S packet at tunnel decapsulation.

In this way, the device supports L4S in wireless and wireline convergence. For example, the device may receive a configuration that triggers the device to prioritize, mark, and/or reflect L4S packets. The device may identify and prioritize upstream and downstream L4S packets based on the configuration. Based on the configuration, the device may mark and queue (e.g., in an L4S queue) downstream L4S packets if there is an overflow and instead of dropping the L4S packets. If an upstream packet is marked as L4S, the device may copy the IP TOS ECN to the GTP-U tunnel IP header based on the configuration. If a downstream packet is marked as L4S in the GTP-U tunnel IP header, the device may copy the IP TOS ECN to the inner packet before forwarding to the subscriber. Thus, the device (e.g., the UPF, the AGF, and/or the BNG) may conserve computing resources, networking resources, and/or other resources that would have otherwise been consumed by failing to prioritize traffic marked as L4S or marked to indicate congestion, losing traffic due to failing to prioritize traffic marked as L4S or marked to indicate congestion, providing a poor user experience due to failing to prioritize traffic marked as L4S or marked to indicate congestion, and/or the like.

As indicated above, FIGS. 1A-1C are provided as an example. Other examples may differ from what is described with regard to FIGS. 1A-1C. The number and arrangement of devices shown in FIGS. 1A-1C are provided as an example. In practice, there may be additional devices, fewer devices, different devices, or differently arranged devices than those shown in FIGS. 1A-1C. Furthermore, two or more devices shown in FIGS. 1A-1C may be implemented within a single device, or a single device shown in FIGS. 1A-1C may be implemented as multiple, distributed devices. Additionally, or alternatively, a set of devices (e.g., one or more devices) shown in FIGS. 1A-1C may perform one or more functions described as being performed by another set of devices shown in FIGS. 1A-1C.

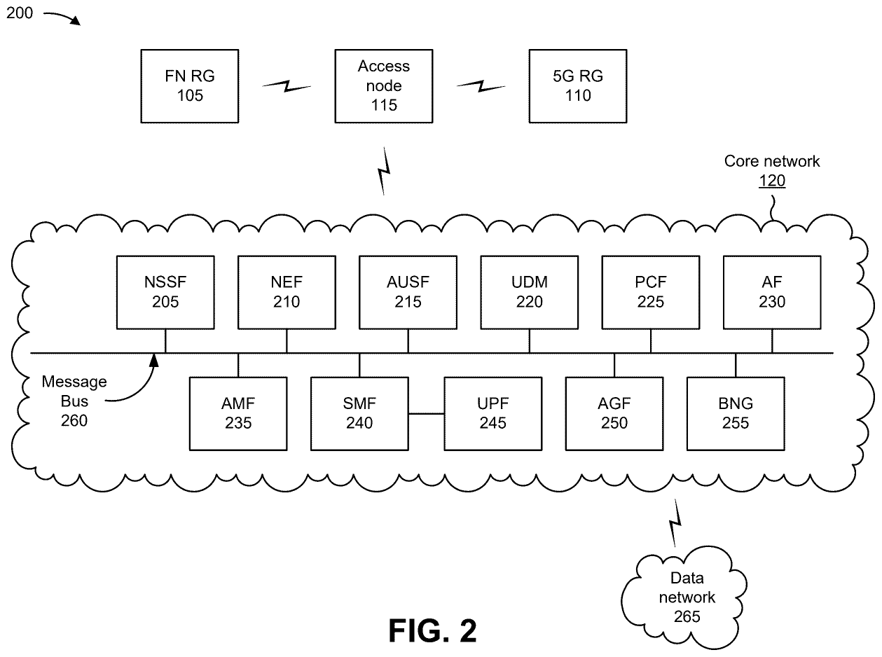

FIG. 2 is a diagram of an example environment 200 in which systems and/or methods described herein may be implemented. As shown in FIG. 2, example environment 200 may include the FN RG 105, the 5G RG 110, the access node 115, the core network 120, and a data network 265. Devices and/or networks of the example environment 200 may interconnect via wired connections, wireless connections, or a combination of wired and wireless connections.

The FN RG 105 includes one or more devices capable of receiving, generating, storing, processing, and/or providing information, such as information described herein. For example, the FN RG 105 may include a device that connects end-user devices within a fixed or wired network (e.g., a home or an office) to an external network (e.g., the Internet or a wide area network (WAN)). The FN RG 105 may facilitate the transfer of data between internal local area networks (LANs) and external networks, performing functions such as routing, network address translation (NAT), and firewalling to ensure secure and efficient data communication. The FN RG 105 may include multiple ports for wired connections and may also offer wireless connectivity options like Wi-Fi. The FN RG 105 may act as a central hub within a fixed network infrastructure, managing data traffic and connectivity, and often incorporating additional features like quality of service (QoS) management and parental controls.

The 5G RG 110 includes one or more devices capable of receiving, generating, storing, processing, and/or providing information, such as information described herein. For example, the 5G RG may provide high-speed Internet connectivity to homes or businesses. The 5G RG 110 may include a mobile hotspot device, a fixed wireless access (FWA) device, a customer premises equipment (CPE), an FWA channel service unit, an FWA data service unit, an FWA router, an FWA wireless access point (WAP) device, an FWA modem, an FWA set-top box, or a similar type of device. The 5G RG 110 may provide wireless Internet access to homes or businesses without laying fiber and cables to provide last mile connectivity.

The access node 115 includes one or more devices capable of receiving, generating, storing, processing, and/or providing information, such as information described herein. For example, the access node 115 may include a digital subscriber line (DSL) access multiplier (DSLAM), an optical line termination (OLT), and/or the like. The access node 115 may receive signals from multiple FN RGs 105 and/or 5G RGs 110 and may multiplex the signals into a single, high-capacity connection to the Internet. The access node 115 may serve as a main data aggregation point for supplying Internet services to multiple end-users via optical fiber. The access node 115 may convert incoming optical signals transmitted over fiber optics back into electrical signals for data processing.

In some implementations, the core network 120 may include an example functional architecture in which systems and/or methods described herein may be implemented. For example, the core network 120 may include an example architecture of a 5G next generation (NG) core network included in a 5G wireless telecommunications system. While the example architecture of the core network 120 shown in FIG. 2 may be an example of a service-based architecture, in some implementations, the core network 120 may be implemented as a reference-point architecture and/or a 4G core network, among other examples.

As shown in FIG. 2, the core network 120 may include a number of functional elements. The functional elements may include, for example, a network slice selection function (NSSF) 205, a network exposure function (NEF) 210, an authentication server function (AUSF) 215, a unified data management (UDM) component 220, a policy control function (PCF) 225, an application function (AF) 230, an access and mobility management function (AMF) 235, a session management function (SMF) 240, a UPF 245, an AGF 250, and/or a BNG 255. These functional elements may be communicatively connected via a message bus 260. Each of the functional elements shown in FIG. 2 is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The NSSF 205 includes one or more devices that select network slice instances for the FWA RG 110. By providing network slicing, the NSSF 205 allows an operator to deploy multiple substantially independent end-to-end networks potentially with the same infrastructure. In some implementations, each slice may be customized for different services.

The NEF 210 includes one or more devices that support exposure of capabilities and/or events in the wireless telecommunications system to help other entities in the wireless telecommunications system discover network services.

The AUSF 215 includes one or more devices that act as an authentication server and support the process of authenticating the FWA RG 110 in the wireless telecommunications system.

The UDM 220 includes one or more devices that store user data and profiles in the wireless telecommunications system. The UDM 220 may be used for fixed access and/or mobile access in the core network 120.

The PCF 225 includes one or more devices that provide a policy framework that incorporates network slicing, roaming, packet processing, and/or mobility management, among other examples.

The AF 230 includes one or more devices that support application influence on traffic routing, access to the NEF 210, and/or policy control, among other examples.

The AMF 235 includes one or more devices that act as a termination point for non-access stratum (NAS) signaling and/or mobility management, among other examples.

The SMF 240 includes one or more devices that support the establishment, modification, and release of communication sessions in the wireless telecommunications system. For example, the SMF 240 may configure traffic steering policies at the UPF 245 and/or may enforce user equipment IP address allocation and policies, among other examples.

The UPF 245 includes one or more devices that serve as an anchor point for intraRAT and/or interRAT mobility. The UPF 245 may apply rules to packets, such as rules pertaining to packet routing, traffic reporting, and/or handling user plane QoS, among other examples.

The AGF 250 includes one or more devices that provide authentication, authorization and accounting (AAA) services and hierarchical traffic shaping and policing for FN and 5G RGs being served from the UPF 245. The AGF 250 may provide a bridge between fixed networks (e.g., broadband services) and mobile core networks (e.g., the core network 120). The AGF 250 may facilitate the convergence of wireline (fixed) and wireless networks by supporting functions, such as subscriber management, session handling, and forwarding of Ethernet frames and IP packets, ensuring seamless integration and communication between different network types.

The BNG 255 includes one or more devices that provide subscribers with access to a broadband network and that connect subscribers to a service provider network. The BNG 255 may aggregate traffic from a plurality of subscribers and may route the traffic to the service provider network (e.g., the core network 120 and/or the data network 265).

The message bus 260 represents a communication structure for communication among the functional elements. In other words, the message bus 260 may permit communication between two or more functional elements.

The data network 265 includes one or more wired and/or wireless data networks. For example, the data network 265 may include an IP Multimedia Subsystem (IMS), a public land mobile network (PLMN), a local area network (LAN), a wide area network (WAN), a metropolitan area network (MAN), a private network such as a corporate intranet, an ad hoc network, the Internet, a fiber optic-based network, a cloud computing network, a third party services network, an operator services network, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the example environment 200 may perform one or more functions described as being performed by another set of devices of the example environment 200.

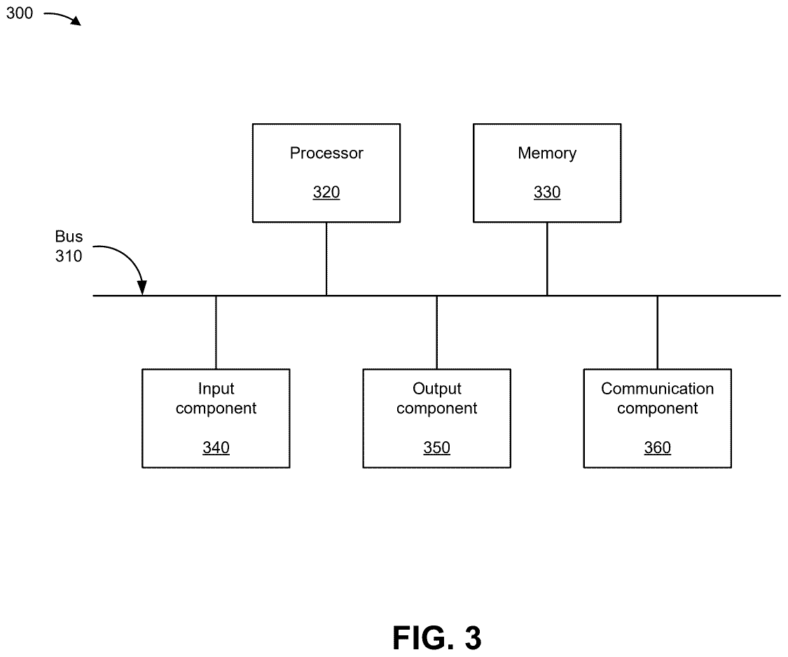

FIG. 3 is a diagram of example components of a device 300, which may correspond to the FN RG 105, the 5G RG 110, the access node 115, the NSSF 205, the NEF 210, the AUSF 215, the UDM 220, the PCF 225, the AF 230, the AMF 235, the SMF 240, the UPF 245, the AGF 250, and/or the BNG 255. In some implementations, the FN RG 105, the 5G RG 110, the access node 115, the NSSF 205, the NEF 210, the AUSF 215, the UDM 220, the PCF 225, the AF 230, the AMF 235, the SMF 240, the UPF 245, the AGF 250, and/or the BNG 255 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit (CPU), a graphics processing unit (GPU), a microprocessor, a controller, a microcontroller, a digital signal processor (DSP), a field-programmable gate array (FPGA), an application-specific integrated circuit (ASIC), and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

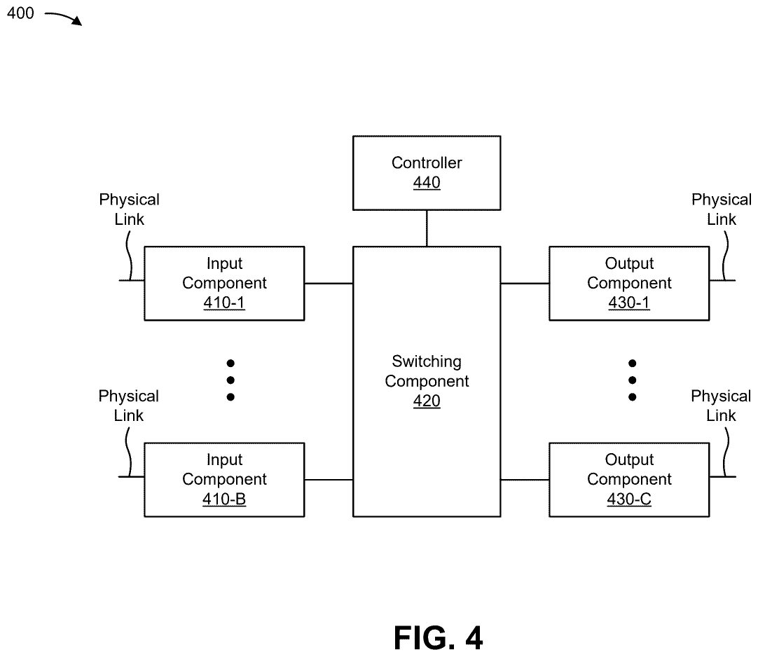

FIG. 4 is a diagram of example components of one or more devices of FIG. 2. The example components may be included in a device 400. The device 400 may correspond to the FN RG 105, the 5G RG 110, the access node 115, the UPF 245, the AGF 250, and/or the BNG 255. In some implementations, the FN RG 105, the 5G RG 110, the access node 115, the UPF 245, the AGF 250, and/or the BNG 255 may include one or more devices 400 and/or one or more components of the device 400. As shown in FIG. 4, the device 400 may include one or more input components 410-1 through 410-B (B≥1) (hereinafter referred to collectively as input components 410, and individually as input component 410), a switching component 420, one or more output components 430-1 through 430-C (C≥1) (hereinafter referred to collectively as output components 430, and individually as output component 430), and a controller 440.

The input component 410 may be one or more points of attachment for physical links and may be one or more points of entry for incoming traffic, such as packets. The input component 410 may process incoming traffic, such as by performing data link layer encapsulation or decapsulation. In some implementations, the input component 410 may transmit and/or receive packets. In some implementations, the input component 410 may include an input line card that includes one or more packet processing components (e.g., in the form of integrated circuits), such as one or more interface cards (IFCs), packet forwarding components, line card controller components, input ports, processors, memories, and/or input queues. In some implementations, the device 400 may include one or more input components 410.

The switching component 420 may interconnect the input components 410 with the output components 430. In some implementations, the switching component 420 may be implemented via one or more crossbars, via busses, and/or with shared memories. The shared memories may act as temporary buffers to store packets from the input components 410 before the packets are eventually scheduled for delivery to the output components 430. In some implementations, the switching component 420 may enable the input components 410, the output components 430, and/or the controller 440 to communicate with one another.

The output component 430 may store packets and may schedule packets for transmission on output physical links. The output component 430 may support data link layer encapsulation or decapsulation, and/or a variety of higher-level protocols. In some implementations, the output component 430 may transmit packets and/or receive packets. In some implementations, the output component 430 may include an output line card that includes one or more packet processing components (e.g., in the form of integrated circuits), such as one or more IFCs, packet forwarding components, line card controller components, output ports, processors, memories, and/or output queues. In some implementations, the device 400 may include one or more output components 430. In some implementations, the input component 410 and the output component 430 may be implemented by the same set of components (e.g., and input/output component may be a combination of the input component 410 and the output component 430).

The controller 440 includes a processor in the form of, for example, a CPU, a GPU, an accelerated processing unit (APU), a microprocessor, a microcontroller, a DSP, an FPGA, an ASIC, and/or another type of processor. The processor is implemented in hardware, firmware, or a combination of hardware and software. In some implementations, the controller 440 may include one or more processors that can be programmed to perform a function.

In some implementations, the controller 440 may include a RAM, a ROM, and/or another type of dynamic or static storage device (e.g., a flash memory, a magnetic memory, an optical memory, etc.) that stores information and/or instructions for use by the controller 440.

In some implementations, the controller 440 may communicate with other devices, networks, and/or systems connected to the device 400 to exchange information regarding network topology. The controller 440 may create routing tables based on the network topology information, may create forwarding tables based on the routing tables, and may forward the forwarding tables to the input components 410 and/or output components 430. The input components 410 and/or the output components 430 may use the forwarding tables to perform route lookups for incoming and/or outgoing packets.

The controller 440 may perform one or more processes described herein. The controller 440 may perform these processes in response to executing software instructions stored by a non-transitory computer-readable medium. A computer-readable medium is defined herein as a non-transitory memory device. A memory device includes memory space within a single physical storage device or memory space spread across multiple physical storage devices.

Software instructions may be read into a memory and/or storage component associated with the controller 440 from another computer-readable medium or from another device via a communication interface. When executed, software instructions stored in a memory and/or storage component associated with the controller 440 may cause the controller 440 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 4 are provided as an example. In practice, the device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

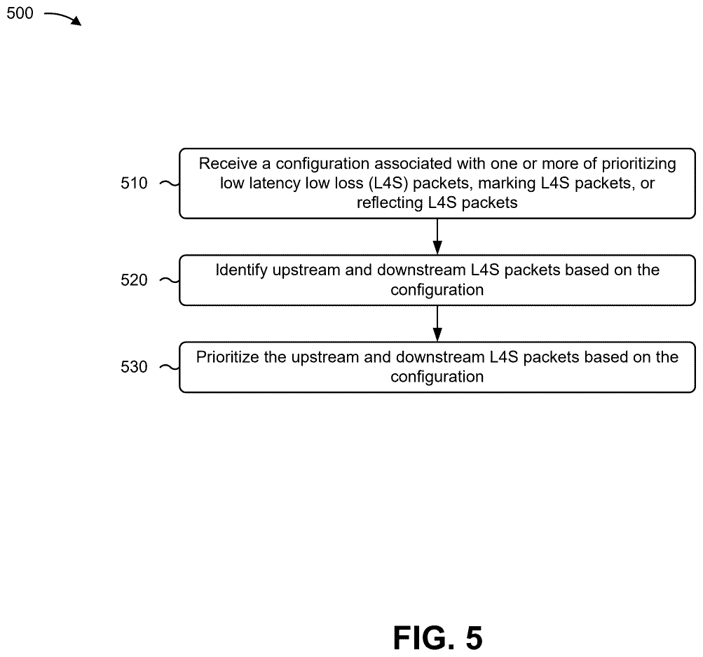

FIG. 5 is a flowchart of an example process 500 for supporting L4S in wireless and wireline convergence. In some implementations, one or more process blocks of FIG. 5 may be performed by a device (e.g., the AGF 250). In some implementations, one or more process blocks of FIG. 5 may be performed by another device or a group of devices separate from or including the device, such as a UPF (e.g., the UPF 245), a BNG (e.g., the BNG 255), and/or the like. Additionally, or alternatively, one or more process blocks of FIG. 5 may be performed by one or more components of the device 300, such as the processor 320, the memory 330, the input component 340, the output component 350, and/or the communication component 360. Additionally, or alternatively, one or more process blocks of FIG. 5 may be performed by one or more components of the device 400, such as the input component 410, the switching component 420, the output component 430, and/or the controller 440.

As shown in FIG. 5, process 500 may include receiving a configuration associated with one or more of prioritizing L4S packets, marking L4S packets, or reflecting L4S packets (block 510). For example, the device may receive a configuration associated with one or more of prioritizing L4S packets, marking L4S packets, or reflecting L4S packets, as described above. In some implementations, the device is one of an AGF, a UPF, or a BNG. In some implementations, receiving the configuration associated with the one or more of prioritizing L4S packets, marking L4S packets, or reflecting L4S packets includes receiving the configuration via a command line interface associated with the device. In some implementations, receiving the configuration associated with the one or more of prioritizing L4S packets, marking L4S packets, or reflecting L4S packets includes receiving the configuration from a residential gateway associated with the device.

As further shown in FIG. 5, process 500 may include identifying upstream and downstream L4S packets based on the configuration (block 520). For example, the device may identify upstream and downstream L4S packets based on the configuration, as described above.

As further shown in FIG. 5, process 500 may include prioritizing the upstream and downstream L4S packets based on the configuration (block 530). For example, the device may prioritize the upstream and downstream L4S packets based on the configuration, as described above. In some implementations, prioritizing the upstream and downstream L4S packets based on the configuration includes providing the upstream and downstream L4S packets in a first queue, providing non-L4S upstream and downstream packets in a second queue, and providing prioritized dequeuing of the first queue over the second queue. In some implementations, prioritizing the upstream and downstream L4S packets based on the configuration includes providing the upstream and downstream L4S packets in a first portion of a queue, and providing non-L4S upstream and downstream packets in a second portion of the queue, wherein the first portion is provided ahead of the second portion.

In some implementations, process 500 includes receiving an indication of downstream congestion, marking downstream L4S packets based on the configuration and the indication of the downstream congestion, and queuing the downstream L4S packets based on the configuration and the indication of the downstream congestion. In some implementations, process 500 includes copying an IP TOS ECN of an upstream L4S packet to a tunnel header or to an inner downstream L4S packet based on the configuration.

In some implementations, process 500 includes establishing a pseudowire with encapsulated explicit congestion notification information for subscriber traffic, and receiving another configuration associated with the pseudowire. In some implementations, process 500 includes identifying upstream and downstream L4S subscriber packets based on the other configuration associated with the pseudowire, and prioritizing the upstream and downstream L4S subscriber packets based on the other configuration associated with the pseudowire. In some implementations, process 500 includes receiving an indication of downstream congestion, marking downstream L4S subscriber packets based on the other configuration and the indication of the downstream congestion, and queuing the downstream L4S subscriber packets based on the other configuration and the indication of the downstream congestion. In some implementations, process 500 includes copying an IP TOS ECN of an upstream L4S subscriber packet to a tunnel header or to an inner downstream L4S subscriber packet based on the other configuration.

In some implementations, process 500 includes receiving an indication of downstream congestion, and marking downstream L4S packets based on the configuration and the indication of the downstream congestion, wherein marking the downstream L4S packets alerts a source of the downstream L4S packets about the downstream congestion.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description but is not intended to be exhaustive or to limit the implementations to the precise form disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, a configuration associated with one or more of prioritizing low latency low loss (L4S) packets, marking L4S packets, or reflecting L4S packets;
identifying, by the device, upstream and downstream L4S packets based on the configuration; and
prioritizing, by the device, the upstream and downstream L4S packets based on the configuration.

2. The method of claim 1, further comprising:
receiving an indication of downstream congestion;
marking downstream L4S packets based on the configuration and the indication of the downstream congestion; and
queuing the downstream L4S packets based on the configuration and the indication of the downstream congestion.

3. The method of claim 1, further comprising:
copying an Internet protocol type of service explicit congestion notification of an upstream L4S packet to a tunnel header or to an inner downstream L4S packet based on the configuration.

4. The method of claim 1, further comprising:
establishing a pseudowire with encapsulated explicit congestion notification information for subscriber traffic; and
receiving another configuration associated with the pseudowire.

5. The method of claim 4, further comprising:
identifying upstream and downstream L4S subscriber packets based on the other configuration associated with the pseudowire; and
prioritizing the upstream and downstream L4S subscriber packets based on the other configuration associated with the pseudowire.

6. The method of claim 4, further comprising:
receiving an indication of downstream congestion;
marking downstream L4S subscriber packets based on the other configuration and the indication of the downstream congestion; and
queuing the downstream L4S subscriber packets based on the other configuration and the indication of the downstream congestion.

7. The method of claim 4, further comprising:
copying an Internet protocol type of service explicit congestion notification of an upstream L4S subscriber packet to a tunnel header or to an inner downstream L4S subscriber packet based on the other configuration.

8. A device, comprising:
one or more memories; and
one or more processors to:
receive a configuration associated with one or more of prioritizing low latency low loss (L4S) packets, marking L4S packets, or reflecting L4S packets;
identify upstream and downstream L4S packets based on the configuration;
prioritize the upstream and downstream L4S packets based on the configuration; and
copy an Internet protocol type of service explicit congestion notification of an upstream L4S packet to a tunnel header or to an inner downstream L4S packet based on the configuration.

9. The device of claim 8, wherein the one or more processors, to prioritize the upstream and downstream L4S packets based on the configuration, are to:
provide the upstream and downstream L4S packets in a first queue;
provide non-L4S upstream and downstream packets in a second queue; and
provide prioritized dequeuing of the first queue over the second queue.

10. The device of claim 8, wherein the one or more processors, to prioritize the upstream and downstream L4S packets based on the configuration, are to:
provide the upstream and downstream L4S packets in a first portion of a queue; and
provide non-L4S upstream and downstream packets in a second portion of the queue,
wherein the first portion is provided ahead of the second portion.

11. The device of claim 8, wherein the one or more processors are further to:
receive an indication of downstream congestion; and
mark downstream L4S packets based on the configuration and the indication of the downstream congestion,
wherein marking the downstream L4S packets alerts a source of the downstream L4S packets about the downstream congestion.

12. The device of claim 8, wherein the device is one of an access gateway function, a user plane function, or a broadband network gateway.

13. The device of claim 8, wherein the one or more processors, to receive the configuration associated with the one or more of prioritizing L4S packets, marking L4S packets, or reflecting L4S packets, are to:
receive the configuration via a command line interface associated with the device.

14. The device of claim 8, wherein the one or more processors, to receive the configuration associated with the one or more of prioritizing L4S packets, marking L4S packets, or reflecting L4S packets, are to:
receive the configuration from a residential gateway associated with the device.

15. A non-transitory computer-readable medium storing a set of instructions, the set of instructions comprising:
one or more instructions that, when executed by one or more processors of a device, cause the device to:
receive, via a command line interface associated with the device or from a residential gateway associated with the device, a configuration associated with one or more of prioritizing low latency low loss (L4S) packets, marking L4S packets, or reflecting L4S packets;
identify upstream and downstream L4S packets based on the configuration; and
prioritize the upstream and downstream L4S packets based on the configuration.

16. The non-transitory computer-readable medium of claim 15, wherein the one or more instructions further cause the device to:
receive an indication of downstream congestion;
mark downstream L4S packets based on the configuration and the indication of the downstream congestion; and
queue the downstream L4S packets based on the configuration and the indication of the downstream congestion.

17. The non-transitory computer-readable medium of claim 15, wherein the one or more instructions further cause the device to:
copy an Internet protocol type of service explicit congestion notification of an upstream L4S packet to a tunnel header or to an inner downstream L4S packet based on the configuration.

18. The non-transitory computer-readable medium of claim 15, wherein the one or more instructions further cause the device to:
establish a pseudowire with encapsulated explicit congestion notification information for subscriber traffic;
receive another configuration associated with the pseudowire;
identify upstream and downstream L4S subscriber packets based on the other configuration associated with the pseudowire; and
prioritize the upstream and downstream L4S subscriber packets based on the other configuration associated with the pseudowire.

19. The non-transitory computer-readable medium of claim 18, wherein the one or more instructions further cause the device to:
receive an indication of downstream congestion;
mark downstream L4S subscriber packets based on the other configuration and the indication of the downstream congestion; and
queue the downstream L4S subscriber packets based on the other configuration and the indication of the downstream congestion.

20. The non-transitory computer-readable medium of claim 18, wherein the one or more instructions further cause the device to:
copy an Internet protocol type of service explicit congestion notification of an upstream L4S subscriber packet to a tunnel header or to an inner downstream L4S subscriber packet based on the other configuration.
